(19) United States
(12) Patent Application Publication
(10) Pub. No.: US 2009/0146390 A1
(43) Pub. Date: Jun. 11, 2009

(54) FORK CROWN AND MANUFACTURING METHOD, IN PARTICULAR FOR BICYCLES

(76) Inventor: Martin Achenbach, Biel (CH)

Correspondence Address: GREER, BURNS & CRAIN, 300 S WACKER DR, 25TH FLOOR, CHICAGO, IL, 60606, US

(21) Appl. No.: 12/327,502

(22) Filed: Dec. 3, 2008

(30) Foreign Application Priority Data
Dec. 4, 2007 (DE) 10 2007 058 587.1

(51) Int. Cl. B62K 21/04; B23P 17/04

(52) U.S. Cl. 280/280; 29/592

(57) ABSTRACT

A fork crown, fork for a bicycle and a method of manufacturing a fork crown including a body having a center portion and a center hole provided thereat for receiving and connection with a steering shaft. Furthermore the body includes two end portions, each of which has a mounting hole for receiving and connection with a fork shaft. The end portions are arranged symmetrically to the center portion and connected with the center portion through elongated legs provided with a hollow space. The legs are provided with a hollow space having an undercut at an accessible end thereof.

### BACKGROUND

The invention relates to a fork crown, as well as a fork so equipped and a method of manufacturing a fork crown. The invention is provided to be employed in bicycles and in particular to be employed in suspension bicycles.

In the field of recreational sports, for amateurs and professional cyclists, the weight of the components is a decisive factor not only in cycle racing but in other bicycle sports as well, such as in mountain biking. At the same time the reliability of the bicycle components must be ensured, in particular for those components contributing to the stability of the bicycle.

Bicycle forks and their fork crowns are crucial components of a bicycle and must have great stability. As a rule, bicycle forks and in particular bicycle suspension forks comprise two stanchions with their top ends retained in a fork crown or a fork bridge. In its center the fork crown is connected with a steering shaft for transmitting steering movements of the cyclist to the fork crown and thus via the stanchions of the fork, to the front wheel.

These fork crowns have been known in the prior art. For reducing the weight of a fork crown, the fork crowns known from the prior art have been provided with hollow spaces in the fork crown body so as to reduce the weight while maintaining the structural volume.

For example U.S. Pat. No. 5,626,355 has disclosed a fork crown which generally consists of five interconnected, hollow tubes, with the steering shaft received in a center portion and the stanchions of the suspension fork received at opposite ends thereof, while the end portions are connected with the center portion through hollowed legs. The known fork crown has a substantially lower weight than do fork crowns of the same size made of solid material. There is, however, the drawback that the large number of bores at the retaining portions may cause a reduction of the rigidity and stability of such a fork crown.

U.S. Pat. No. 6,095,542 has disclosed a different fork crown which basically has the shape of an inverted U and where the legs connecting the center portion with the end portions are hollowed, with the bore in the legs configured as a blind bore so as to reduce the number of through bores at the retaining portions. Moreover, the leg bores are manufactured starting from the end portions with the drill inserted through the open cross-sectional area at the end. Although this will result in a sturdy fork crown, more material than necessary will be present in various places. At the same time, more material might be provided in other places for improving stability.

US 2006/0186632 A1 has disclosed another fork crown comprising various hollow spaces to reduce the weight. Each leg is provided with two bores separated from one another by a bridge. It is another disclosed option to make a large, lateral opening into the tube wall of the tube-type legs to thus reduce the total weight. However, the drawback of this configuration is that the tubular leg wall is extensively perforated which may considerably adversely affect the overall stability of the legs and the fork crown on the whole. To achieve reasonable stability, the thickness of the other walls must thus be increased which in turn will increase the total weight.

Against this technical background it is the object of the present invention to provide a fork crown as well as a fork and a method of manufacturing a fork crown so as to provide a stable yet lightweight fork crown.

### SUMMARY

The fork crown according to the invention is provided for a fork in particular of a bicycle, comprising a body with a center portion and a center hole provided thereat for receiving a steering shaft to thus connect the body with a steering shaft. Furthermore the body of the fork crown according to the invention comprises two end portions, each comprising a mounting hole for receiving and connection with a fork shaft. The end portions are arranged approximately symmetrically to the center portion and connected with the center portion through in particular elongated legs provided with at least one hollow space. According to the invention at least one leg comprises at least one hollow space which comprises an undercut at an accessible end thereof.

The invention has many advantages. One considerable advantage of the invention is enhanced flexibility in designing the body since the hollow space does not need to be uniform in cross-section but it is non-uniform in cross-section in relation to the geometrical conditions. In particular at its front end the hollow space is provided with a smaller clear diameter so as to not compromise the stability of the component. Since the fork crown will receive one fork shaft in each of its end portions, said end portions need to provide sufficient wall thickness and a sufficient supporting surface at the mounting hole to securely receive the fork shaft, which is possible in this way.

It is a considerable advantage of the fork crown according to the invention that more material is present at the contact areas with the fork shafts or the steering shaft so as to improve durability while also allowing an increase of the hollow space, which will decrease the total weight.

There is another and very considerable advantage in that the contact area with the stanchions will increase such that the contact pressure will decrease while the strength is maintained.

There is also the additional advantage of enhanced elasticity such that the fork crown according to the invention does not transmit the typical high stresses to the adjoining components. The increased elasticity with sufficient stability thus affords considerable advantages.

The in particular elongated hollow space preferably has an internal diameter that is larger in a center leg region than in an accessible end of the hollow space. This means that in the case of a configuration e.g. in the shape of a blind bore the hollow space has an internal diameter that is larger in a center leg region than at the beginning of the bore in the region of the end portion. In all of the embodiments the hollow space is preferably elongated, extending approximately parallel to the leg.

The fork crown or fork bridge is in particular manufactured integrally and preferably it is at least approximately mirror-image symmetrical, wherein at least one plane of symmetry is in particular oriented approximately perpendicular to the line connecting the two end portions.

When used as intended, the center hole and the mounting holes are preferably oriented upwardly and they may be e.g. approximately vertical. A vertical orientation in the sense of the present application is understood to include an angular deviation of one and in particular two degrees, or several degrees from the vertical as is typical in bicycle construction.

The fork shaft is in particular configured as a fork tube and preferably designed as a stanchion.

Preferably the hollow space of at least one leg comprises an undercut which may in particular extend over the entire periphery. One significant advantage of such a configuration is that in the region of the center hole or the end portion, the initial diameter of the hollow space is smaller so as to allow an enhanced force transmission to the fork shaft or the steering shaft through a larger contact area, while due to the undercut the hollow space is larger in volume such that the total weight of the fork crown can be reduced.

Preferably the legs or fork crown legs are inclined relative to the horizontal, extending from the center portion to the side and inclined downwardly. Preferably, a projected area of the largest hollow space cross-section onto a plane containing the opening of the mounting hole at the end portion, is larger than the area of the mounting hole opening. The hollow space may have a cross-section larger than the cross-section of the mounting hole at the end portion. It is not necessary for the cross-sectional area of the hollow space projected onto the opening area of the mounting hole to be smaller for inserting the drill but to the contrary, the hollow space cross-section may be provided to be larger than the mounting hole opening.

In another embodiment it is possible for the opening area of the mounting hole at the end portion to be entirely within the projected area of the largest hollow space cross-section onto the plane containing the mounting hole opening at the end portion.

In other embodiments it is also conceivable that the projected area remains within the opening area of the end portion, for example where the weight is not particularly relevant or a particularly high stability is intended.

In another preferred embodiment the hollow space is configured as a through hole, connecting the center hole in the center portion with the mounting hole in the end portion. Then it is conceivable for both ends of the hollow space to be provided with an undercut such that, both toward the through hole and toward the mounting hole, the outlet openings of the hollow space have a smaller clear diameter than does a cross-section of the hollow space in a center region of the leg. Since the bore or the hollow space has a smaller diameter at the connecting points with the center hole or the mounting hole, the stability of the fork crown is not adversely affected on the whole while at the same time the weight is reduced. Again in this case, a large contact area is available so as to allow a reduction of contact stresses.

In particularly preferred embodiments the hollow space is milled out.

Preferably the hollow space is entirely surrounded in the peripheral direction by the body of the fork crown or the leg so as to not weaken the structure of the fork crown relative to the occurring loads. Therefore the leg preferably comprises only minuscule or in particular no radial holes or bores to ensure the required stability by way of the substantially closed peripheral wall.

In all of the embodiments it is preferred for the center hole and the distal mounting holes to be oriented approximately parallel relative to one another. The center hole and the distal mounting holes extend substantially upwardly. The holes may be oriented vertical, or else they may comprise an angle of e.g. 20° to the vertical, depending on the configuration.

Although the mounting holes and the center hole are preferably substantially round, an oval, rounded, or polygonal shape is conceivable and preferred as well.

Preferred more specific embodiments may provide for the end portions to have beveled edges to reduce the weight and decrease contact stresses toward the handlebar and the fork shafts.

In another preferred more specific embodiment two or more hollow spaces are provided in each leg, wherein at least one hollow space is undercut.

The fork crown preferably consists of a lightweight material, in particular of a light metal or a light metal alloy; or else the fork crown may consist in part or entirely of a fibrous composite material.

The fork according to the invention is in particular provided for a bicycle, comprising a steering shaft, two fork shafts, and a fork crown. Said fork crown comprises a body with a center portion and a center hole provided therein for mountreceive and connection with the steering shaft. The fork crown is furthermore provided with end portions, each comprising a mounting hole for receiving and connection with the fork shaft. The end portions are arranged at least approximately symmetrically to the center portion and connected with the center portion through elongated legs provided with a hollow space. According to the invention at least one leg comprises at least one in particular elongated hollow space which in a center region of the leg has a larger internal diameter than at an accessible end.

The fork according to the invention also comprises considerable advantages since the invention allows to manufacture a robust fork which is more lightweight than in the prior art.

The fork according to the invention is preferably equipped with a fork crown as described above.

By means of the method according to the invention a fork crown comprising a body is manufactured. The fork crown is manufactured such that the body comprises a center portion with a center hole for receiving and connection with a steering shaft and two end portions, each comprising one mounting hole for mounting and connecting with a fork shaft. The end portions are arranged approximately symmetrically to the center portion and connected with the center portion through in particular elongated legs. According to the invention a hollow space is made in at least one leg comprising an undercut at an accessible end thereof.

The method according to the invention allows a more variable manufacture of an inventive fork crown, while allowing to manufacture a more lightweight though more robust fork crown.

For manufacturing the hollow space, a milling tool having a shoulder is preferably employed which milling tool is inserted in the leg when making the hollow space and then displaced at least in one direction transverse to its longitudinal direction to produce an undercut at the leg. The undercut may be provided around the circumference or it may extend over an angular portion only.

### BRIEF DESCRIPTION OF THE DRAWINGS

Further advantages and features can be taken from the embodiment which will now be described with reference to the enclosed Figures.

FIG. 1 is a front view of an inventive fork crown;

FIG. 2 is a top view of the fork crown according to FIG. 1;

FIG. 3 is a section A-A from FIG. 2; and

FIG. 4 is an enlarged illustration of detail B from FIG. 3.

### DETAILED DESCRIPTION

With reference to the Figures an embodiment of a fork crown 1 according to the invention will now be described, which is also employed in an inventive fork for a bicycle (not shown).

The fork crown 1 is an integral configuration on the whole, comprising a body 2 which includes a middle center portion 3 and two legs 9, 10 adjoining in opposite directions thereof and connecting the center portion 3 respectively with the end portions 5 and 6. The side legs extend inclined downwardly at the angle 17 to the horizontal 16.

The center portion 3 comprises a center hole 4 which serves for receiving a steering shaft connected with the steering device of the bicycle for transmitting the steering movements of the rider from the steering shaft via the fork crown to the fork shafts (not shown) connected thereto and configured in particular as stanchions, such that the bicycle wheel is steered as the rider intends.

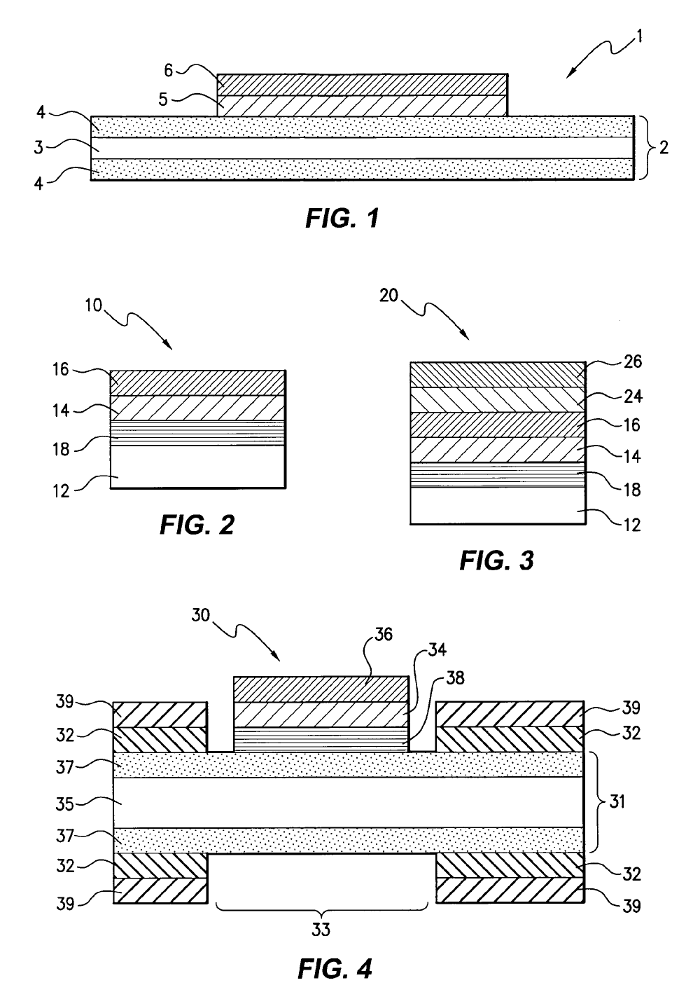

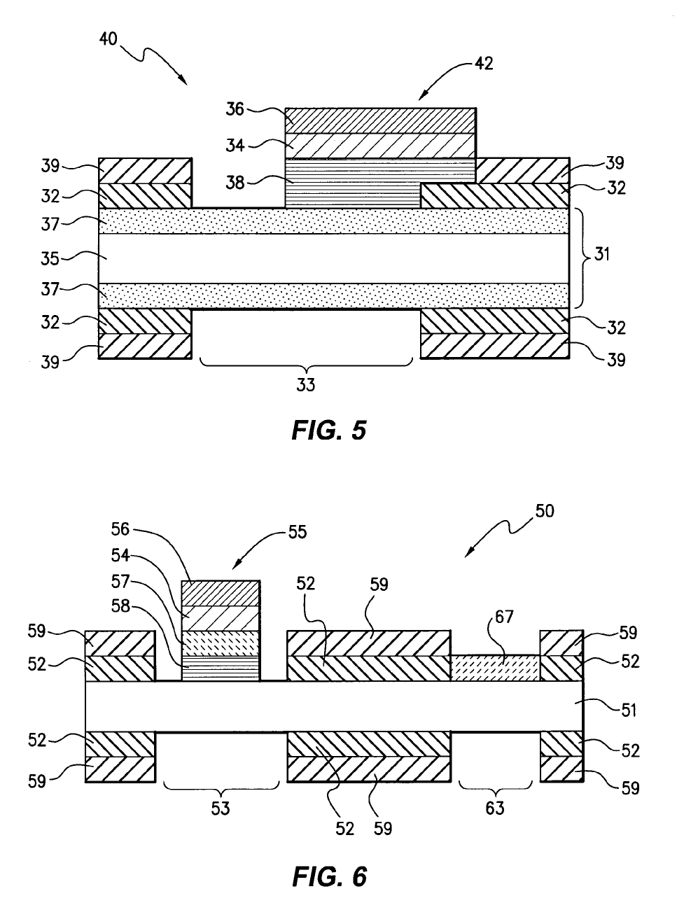

In the front view of FIG. 1 on the left, an end portion 5 with a mounting hole 7 is provided, while on the right the receiving portion 6 with the mounting hole 8 is provided.

Since the fork crown 1 must transmit a considerable steering force while it may also be submitted to large impact forces, the fork crown needs to be configured correspondingly robust. At the same time, however, a low weight is desired so as to meet superior requirements.

To reduce the total weight, the legs 9 and 10 of the fork crown 1 are provided with hollow spaces 11 and 12 (see FIG. 3) which in the present embodiment have been manufactured by milling out the legs 9 and 10 and which are elongated in shape.

To this end, the milling tool 23 illustrated in FIG. 3 is inserted through the bottom opening 31 of the mounting hole 7 approximately parallel to the orientation of the leg 9 in the longitudinal direction 33. First, a straight hole is drilled or milled in the leg. The outer diameter 21 of the milling head 24 is dimensioned such that it will not come into contact with the projecting edge 27 or the lug 18 as it is inserted into the leg 9 but it enters the mounting hole 7 through the clear opening area 32 of the bottom opening 31.

Since, given these dimensions, the size of the hollow space to be manufactured is limited, and to furthermore achieve optimum stability combined with low weight, the milling head 24, with the milling tool 23 inserted, is subsequently displaced transverse or even perpendicular to its longitudinal direction 33 at least in the transverse direction 26, to thus obtain a diameter 29 in the center region of the hollow space which is larger than the diameter 21 of the milling head 24.

By way of this measure the wall thickness is optimized in the region of the legs 9, 10, while at the same time the legs 9, 10 maintain their tube-like structure which in this embodiment is not interrupted in any place in the radial direction such that a particularly high stability is achieved.

Other embodiments may provide small, radial holes, as long as the overall stability and rigidity of the leg 9 or 10 is not inadmissibly reduced, in particular in view of the risk of kinking.

Since the milling tool 23 has a shoulder portion and the outer diameter 21 of the milling head 24 is thus larger than the outer diameter 22 of the milling-cutter shank 25, the movements of the milling tool transverse to the longitudinal direction 33 of the milling tool 23 when drilling the hollow space will not remove neither the lug 18 nor the projecting edge 27 but generate an undercut.

It may possibly be sufficient to provide only one undercut 13 or 27 in the region of or at the lug 18 or at the projecting edge 27. The undercut may extend in one region only or over an angular section, or two or more undercuts may be provided.

An undercut or multiple undercuts offer significant advantages since in this way an increased stability of the fork crown is achieved on the whole because the contact surface of the end portion 5 in the mounting hole 7 will be increased by means of a stanchion of the bicycle fork in the region of the lug 18 and/or in the region of the projecting edge 27. In this way, the contact surface with the stanchion is enlarged on the one hand, while on the other hand the wall thickness provided at the contact surfaces may be reduced since in the region of the lug 18 the undercut 13 is provided such that by means of the fork crown 1 according to the invention, a particularly lightweight but also robust fork crown is provided.

To further reduce the total weight, beveled edges may be provided in the region of the top and bottom ends of the end portions as well as in the region of the center portion, such as those shown at the end portion 5 at the reference numeral 28. Such a beveled edge 28 not only reduces the total weight but also increases stability since the rigidity of the fork crown is reduced such that the bending forces transmitted to the clamped-in component are reduced.

As can be seen in FIG. 3, the milling tool 23 can be moved not only in the transverse direction 26 but also in a direction transverse and e.g. perpendicular to the direction of movement 26. Moreover, the milling tool 23 can be displaced in the longitudinal direction 33 during milling so as to obtain a hollow space that is three-dimensional on the whole and may, but is not required to, comprise an axis of symmetry or a plane of symmetry.

In manufacturing the hollow space 11 or 12 the milling tool 23 preferably enters the leg 9 or 10 until such a depth that a specific, minimum wall thickness will be maintained at the end of the center portion 3 adjoining the center hole 4. In specific embodiments it is likewise conceivable to configure the hollow space 11 or 12 as a through hole such that the hollow space 11 or 12 connects the center hole 4 with the mounting hole 7 in the end portion 5 or with the mounting hole 8 in the end portion 6.

Although in this embodiment described last, the center hole 4 is not entirely enclosed in the material of the center portion, the stability achieved will be very great, in particular in the case that the through hole has an undercut such that the center portion is not significantly weakened.

On the whole the invention provides a lightweight and robust fork crown since the legs are drilled hollow while at the same time allowing a large mating surface of the fork crown with the stanchions or the steering shaft. Moreover, a comparatively constant radial wall thickness is possible which is not weakened by holes such that a particularly lightweight and robust fork crown is provided.

1. A fork crown for a fork of a bicycle,
Comprising: a body having a center portion and a center hole provided thereat for receiving and connection with a steering shaft and having two end portions, each of which includes one mounting hole for receiving and connection with a fork shaft,
wherein the end portions (are arranged approximately symmetrically relative to the center portion and connected with the center portion through legs elongated in shape and provided with hollow spaces; and
at least one leg comprises at least one hollow space which includes at least one undercut at an accessible end thereof.

2. The fork crown according to claim 1, wherein in a center portion of the leg the at least one hollow space has a larger internal diameter than at its accessible end.

3. The fork crown according to claim 1, wherein the legs are arranged at an incline relative to the horizontal.

4. The fork crown according to claim 1, wherein a projected area of the largest cross-section of the at least one hollow space protrudes in one dimension beyond the area of the opening of the mounting hole onto a plane which contains the opening of the mounting hole at the end portion thereof.

5. The fork crown according to claim 4, wherein an opening area of the mounting hole at the end portion is entirely contained within the projected area of the largest cross-section of the at least one hollow space.

6. The fork crown according to claim 1, wherein the at least one hollow space is configured as a through hole, connecting the center hole in the center portion with the mounting hole in the end portion.

7. The fork crown according to claim 1, wherein the hollow space is milled out.

8. The fork crown according to claim 1, wherein the hollow space is entirely surrounded in the peripheral direction by a leg wall.

9. The fork crown according to claim 1, wherein the center hole and the mounting holes are arranged approximately in parallel with a deviation, if any, in particular being less than 15 degrees.

10. The fork crown according to claim 1, wherein the center hole and the mounting holes extend substantially upwardly.

11. The fork crown according to claim 1, wherein the center hole in the center portion is configured round.

12. A fork, in particular for a bicycle,
Comprising: a steering shaft, two fork shafts and a fork crown, which fork crown includes a body having a center portion and a center hole provided thereat for receiving and connection with the steering shaft, and end portions, each of which have a mounting hole for receiving and connection with the fork shaft,
wherein the end portions are arranged approximately symmetrically relative to the center portion and are connected with the center portion through legs elongated in shape and provided with hollow spaces; and
at least one leg includes at least one hollow space which has an undercut at an accessible end thereof.

13. A method of manufacturing a fork crown having a body which is manufactured such that it includes a center portion with a center hole for receiving and connection with a steering shaft, and two end portions each of which have one mounting hole for receiving and connection with a fork shaft, wherein the end portions are arranged approximately symmetrically relative to the center portion and are connected with the center portion through elongated legs, comprising: in at least one leg a hollow space is produced which comprises an undercut at an accessible end thereof.

14. The method according to claim 13, wherein, for manufacturing the hollow space, a milling tool having a shoulder is employed, which milling tool is inserted in the leg (and is displaced transverse to its longitudinal direction to manufacture an undercut at the leg.
